(19) United States
(12) Patent Application Publication
(10) Pub. No.: US 2011/0200703 A1
(43) Pub. Date: Aug. 18, 2011

(54) One handed ice cube tray

(76) Inventor: Gilbert Robert Taylor, Niagara Falls (CA)

(21) Appl. No.: 12/656,653

(22) Filed: Feb. 12, 2010

(51) Int. Cl. B28B 7/06

(52) U.S. Cl. 425/440

(57) ABSTRACT

The one handed ice cube tray is an ice cube tray with a large opening that works like a hand that holds the front edge of a kitchen counter top to secure that end of the ice cube tray to allow one hand to twist or flex the ice cube tray and hold it flexed to ensure the ice cubes remain elevated to allow the other free hand to take out the desired amount of ice cubes.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF INVENTION

Flexible plastic ice cube trays are common place around the world today. The main drawbacks with most of these flexible ice cube trays is that when you flex these ice cube trays using two hands, the ice cubes rise upwards enough to retrieve, but soon as you stop flexing the ice cube tray to retrieve the ice cubes the ice cubes recede back down into their individual compartments, thus making it difficult to remove desired amount of ice cubes. The ice cube tray may be inverted to remove the ice cubes into a container often spilling some of the ice cubes on the counter top or on the floor.

### BRIEF SUMMARY OF THE INVENTION

My invention relates to flexible ice cube trays particularly a way to flex the ice cube tray with the use of one hand so that there is a free hand to retrieve the desired amount of ice cubes.

A large opening on one end of the ice cube tray that preferably has a front edge of a standard size kitchen counter top fit into it to secure that end of the ice cube tray when twisting the one handed ice cube tray.

### BRIEF DESCRIPTION OF SEVERAL VIEWS OF THE DRAWING

FIG. 1 is a perspective view of an ice cube tray with an aperture on one end of the ice cube tray in accordance with the invention.

FIG. 2 is a side view of the aperture end of the ice cube tray in accordance with the invention.

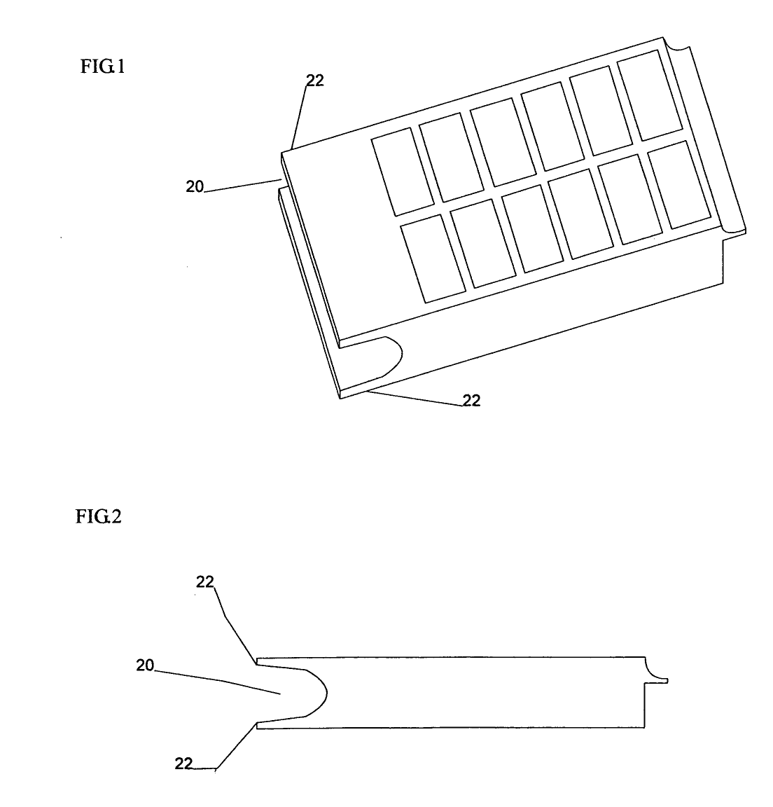

### DETAILED DESCRIPTION

Referring to the drawings in detail the one handed ice cube trays objectives are accomplished in accordance with the present invention by having large aperture 20 on one end of said tray; the length of the aperture 20 is preferred to be the same size as said tray is wide; the height of the aperture 20 is preferred to be large enough to receive the front edge of a standard size kitchen counter top; the aperture 20 depth is preferred to be deep enough to secure said tray to said counter top when flexing the one handed ice cube tray left or right; it is preferred that the thickness of the sleeves 22 that circum the said counter top are to be smaller at the front and gradually thicker towards the back thus allowing the front of the aperture 20 to be forced open to receive larger counter tops into it; the back of the aperture 20 is preferred to be half round or half cylindrical shape throughout the length of the aperture 20; thus adding strength to the sleeves 22 when flexed.

The one handed ice cube tray is to receive a secured standard size kitchen counter top to fit between the aperture 20 end on said tray; the sleeves 22 are strong and flexible enough to be twisted up or down to hold said end secure to the counter top to allow the ice cube tray to be flexed or twisted with the use of one hand, thus allowing one hand to be free to remove the desired amount ice cubes

The one handed ice cube tray is preferred to be molded into one piece from one of the flexible plastics commonly used.

1. An ice cube tray that is adapted to have an aperture on one end that is large enough to fit the front edge of a standard size kitchen counter top into it, to assist in securing aperture end of the ice cube tray, thus allowing said tray to be flexed with the use of one hand.

2. An ice cube tray in accordance with claim 1 wherein the ice cube tray is made from a flexible material, preferably polypropylene.

3. An ice cube tray in accordance with claim 1 wherein the ice cube tray is made from a mold cast, in particular one single mold cast.
